(19) United States
(12) Patent Application Publication
(10) Pub. No.: US 2012/0123572 A1
(43) Pub. Date: May 17, 2012

(54) SYSTEM AND METHOD FOR ADDING LYRICS TO DIGITAL MEDIA

(76) Inventor: Mitch Junkins, Newport Beach, CA (US)

(21) Appl. No.: 13/297,883

(22) Filed: Nov. 16, 2011

Related U.S. Application Data
(60) Provisional application No. 61/414,109, filed on Nov. 16, 2010.
(60) Provisional application No. 61/421,835, filed on Dec. 10, 2010.

(51) Int. Cl. G06F 17/00

(52) U.S. Cl. 700/94

(57) ABSTRACT

The present invention describes a method and system for displaying and adapting lyrical content for digitally downloaded media such as audio media to a portable media device. The invention provides that an individual having a portable media device may download digital content from a remote third party server, and if desired may also download a separate and distinct lyrical data which may or may not be synchronized with the originally downloaded digital audio media. Further, the invention may allow for digital images, pictures, and video content to be downloaded along with the lyrical content to add entertainment and visual qualities to both the first downloaded digital content such as audio data and to the lyrical content desired by the individual user.

### PRIORITY CLAIM

This application claims priority to the earlier filed U.S. Provisional Application No. 61/414,109 filed on Nov. 16, 2010, entitled “System and Method for Adding Lyrics and Video Content to Existing Audio Media” and U.S. Provisional Application No. 61/421,835 filed on Dec. 10, 2010, entitled “System and Method for Adding Lyrics and Video Content to Existing Audio Media”, the content of which is hereby incorporated by reference in its entirety.

### FIELD OF THE INVENTION

The field of the invention is for digital media. More specifically, the field of invention is for a system and method of adding lyrics to digital media, such as digital music stored on a digital music device.

### BACKGROUND

Historically, when an individual bought an audio product such as a cassette, LP, or CD, the audio product typically came with the product itself, such as the CD and a physical component consisting of a cover and insert that introduced the artist, copyright information and often times, a copy of the lyrics for use by the individual who purchased the audio product. However, much of today's music is not purchased from a retailer and the audio product is typically digital media, not a cassette, LP, or CD. For example, CD players, MP3 players, computers, and cellular phones are now all capable of playing digital music that is either uploaded to the device from another device, or is downloaded directly from a remote service to the digital music player, such as a MP3 player. However, a problem with this type of digital media that is downloaded or uploaded from another remote device is that the digital content is only the media downloaded. Often times, the songs and artists are not regularly known and often times, the media may not contain all the information that was available to the individual purchaser had that individual bought an actual audio product such as the physical CD or LP. An example of this is the exclusion from digital audio media of lyrics. Lyrics were typically available for songs that were previously purchased as part of the audio product. For example, when purchasing a CD, lyrics were often provided with the purchase of that CD on liner notes, the printed material provided within a CD. However, when an individual now purchases digital media such as songs from an online music store, typically the associated lyrics are embodied only on the song purchased and are not separately available to an individual purchaser with the downloaded song. For example, the individual that purchases music from an online store would only obtain the digital song to their device, such as an MP3 player, computer or cellular phone system.

In order for the individual to obtain a copy of the song's lyrics, they would have to search online for a copy of the lyrics, which may or may not be available to them. Additionally, if the individual was able to find the associated lyrics and obtain them via a download, the lyrics would be stored as a separate file that could not be associated with the downloaded music file they had previously obtained.

There are devices such as karaoke machines that utilize the display of lyrics to a user of digital music and the like. In these types of machines, the user is attempting to sing along with the music and the lyrics are provided to the user to enable them to sing along. The karaoke machine plays a song and displays the appropriate lyrics to the user who can then read the lyrics while attempting to sing along with the associated song being played.

A problem with karaoke machines is that typically the music must be bought specifically for that intended purpose. For example, the music purchased for a karaoke machine is specific to that product as the music only provides the background music and background accompaniment. The original singer's voice is not heard or sold in combination with the music provided for those karaoke machines. Therefore, the user is the only person providing the vocals for that particular music selection. Additionally, the music sold for karaoke machines have associated lyrics provided specifically for that music as a unit. More specifically, the music and lyrics are not separate files or programs. They are sold in combination for the specific purpose of allowing a user to sing along with the music selection. The lyrics cannot be removed from the selected song.

Computers are able to play music, such as by playing audio files (e.g., MP3 files). Software programs are now available that allow a user of a personal computer to operate the personal computer such as MP3 files having embedded karaoke lyrics can cause the lyrics to be displayed on the computer screen while the song is playing. Even so, these programs require preparatory action by the user to embed (or bind) the lyrics from a lyrics file into a MP3 file. Such a procedure is prone to error and can lead to inaccurate lyrics,

In today's society, most music listeners utilize hand-held portable media devices such as MP3 players and cellular devices that are capable of playing digital media. Although portable media devices often include a display screen, these devices tend to be very small and do not provide for an intelligent display of lyrics while playing songs. Accordingly, there is a need for improved techniques to enable users of portable media devices to view the lyrics associated with songs being played by such portable media devices.

A need also exists for a method and system to allow the user to download music content to their media devices and to separately download and adapt lyrics from a remote server to their media device for use with the separately downloaded music. Moreover, a need exists for a system and method of downloading other digital media such as photographs, pictures, and video content along with the lyrics to be associated with any digital media located on a portable media device.

### SUMMARY OF THE INVENTION

The present invention describes a method and system for displaying and adapting lyrical content for digitally downloaded media such as audio media to a portable media device. The invention provides that an individual having a portable media device may download digital content from a remote third party server, and if desired may also download a separate and distinct lyrical data that may or may not be synchronized with the originally downloaded digital audio media. Further, the invention may allow for digital images, pictures and video content to be downloaded along with the lyrical content to add entertainment and visual qualities to both the first downloaded digital content such as audio data and to the lyrical content desired by the individual user.

Among the many different possibilities contemplated, the system may be utilized to allow for lyrical information for digital music to be provided.

Additionally, in an exemplary embodiment, the system and method may allow for lyrical content to be provided to an individual user when no such information is provided with the musical content.

To this end, in an exemplary embodiment of the present invention a method for providing lyrics for a portable music device, the method comprising the steps of: downloading an audio file from a remote third party server; wherein the audio file contains audio content; providing a lyrical file having only lyrics associated with the audio file previously downloaded from the remote third party server, whereby the lyrical file may be provided by a different third party server or the same third party server that provided the audio file; playing the audio content from the identified audio file; and compiling the lyrical file on top of the audio file to display lyrics from the lyrical file when desired by the individual user.

In an exemplary embodiment, wherein the lyrical file further includes any of the lyrics for the audio file and includes other visual portions.

In an exemplary embodiment, wherein said visual portions include pictures, video display, and other visual cues to facilitate the individual user to learn the lyrics for a particular audio file.

In an exemplary embodiment, wherein the audio file contains no visual content.

In an exemplary embodiment, wherein said lyrical file is removably displayed on the portable music device and is displayed and withdrawn as desired by the individual user.

In an exemplary embodiment, wherein the lyrical file is displayed on the portable music device as desired by the individual user.

In an exemplary embodiment, wherein the lyrical file may be synchronized to music in three dimensional or other dimensional format.

In an exemplary embodiment, wherein the lyrical file data may be streamed or populated across a radio screen or the portable device screen when such lyrical file data is available.

In an exemplary embodiment, wherein the portable media device may be a cellular phone, a MP3 player, a portable tablet, a DVD or CD player, a radio with text capability.

In an exemplary embodiment, wherein the individual user may vary by speed by which the lyrics are displayed.

In an exemplary embodiment, wherein the individual user may change an appearance of the lyrics that are displayed.

In an exemplary embodiment, wherein the individual user may highlight, notate, or copy one or more words of the lyrics that are displayed.

In yet another exemplary embodiment, it is contemplated that the system and the method may allow for download of digital media from a third party remote server.

In another exemplary embodiment, it is contemplated that the system and method allows for a separate download of digital audio media and lyrics from separate third party remote servers.

Another exemplary embodiment is that a system and method is provided whereby the lyrical content may be separately downloaded for a particular digital music content after the digital music content has first been downloaded.

A further exemplary embodiment contemplates that the system and method may allow for lyrical content along with video content such as pictures, movies and the like to be packaged together and downloaded to an individual personal music player device and combined with digital information such as music already stored in said device.

Further, a contemplated embodiment of the system and method is to provide lyrical content which may be combined and separated from the music on the portable digital player apparatus as desired by the individual. For example, the individual user may want the lyrics displayed with the music to learn the words of the music that exists in storage of the portable player device. However, after the individual user has learned the particular lyrics of the music stored, they may wish to separate the musical content from the lyrics such that the lyrics are no longer displayed and the individual user may know the lyrics by memory instead of needing to visually see the text of the lyrics.

Additionally, in an exemplary embodiment, a system and method is provided such that lyrical content is downloaded that may be combined and separated from the music on the portable digital player apparatus as desired by the individual and further wherein video or graphical information is provided with the lyrical content to allow for easier memorization of lyrics for a particular music content embodied on the portable music device. For example, the individual user may want to learn the lyrics for a particular musical piece, but finds it difficult to follow the lyrics displayed. The present invention may combine the lyrical content with visual cues, graphical content, and other visual information to facilitate faster learning, or easier understanding of the lyrics embodied in the desired musical piece. However, after the individual user has learned the particular lyrics of the music stored, they may wish to separate the musical content from the lyrics such that the lyrics are no longer displayed and the individual user may know the lyrics by memory instead of needing to visually see the text of the lyrics.

A further exemplary embodiment of the present invention may be to provide lyrical content to a user whereby the user may download the lyrical content for each individual music piece embodied on their portable player device.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates an embodiment of a system and method for adding lyrics and video content to an audio media device.

### DETAILED DESCRIPTION OF THE PREFERRED EMBODIMENT

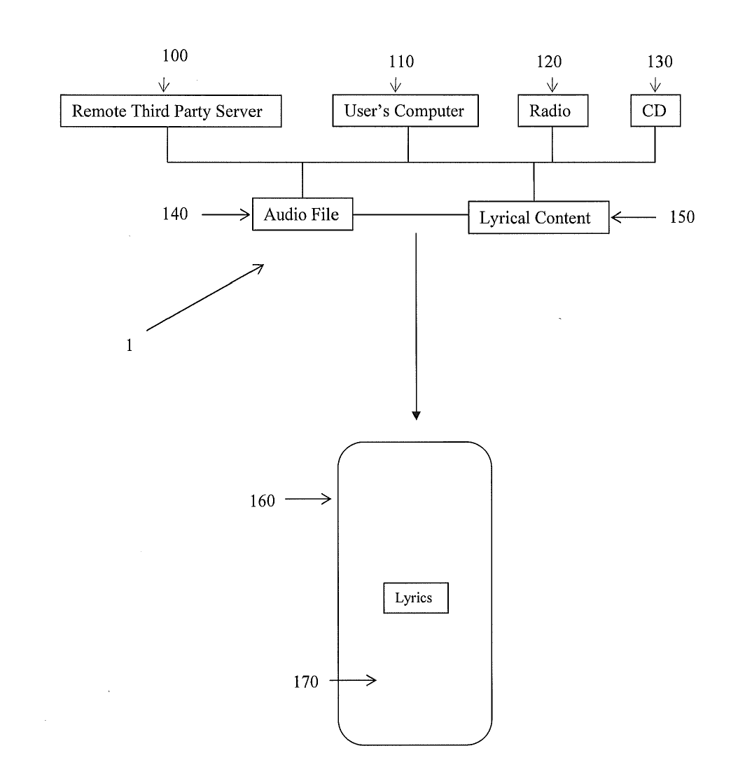

With reference to FIG. 1, the present invention describes a method and system 1 for displaying and adapting lyrical content for digitally downloaded media such as audio media to a portable media device. The invention provides that an individual having a portable media device 160 may download digital content from a remote third party server 100, and if desired may also download a separate and distinct lyrical data that may or may not be synchronized with the originally downloaded digital audio media. Further, the invention may allow for digital images, pictures, and video content to be downloaded along with the lyrical content to add entertainment and visual qualities to both the first downloaded digital content such as audio data and to the lyrical content desired by the individual user.

A user may access lyrics in an audio file by first downloading an audio file from a remote third party server 100, such as an online retailer of audio music. Alternatively, the audio file 170 may be accessed from a user's computer 110, from the radio 120, from a physical source, such as a CD 130, or from any source where audio files may be obtained. It may be appreciated that while FIG. 1 illustrates an embodiment where files are downloaded from a remote third party server 100, a user's computer 110, the radio 120, or a CD 130, other sources of audio files are encompassed within the scope of the invention 1.

The user may then access a lyrical content 150 having only lyrics associated with the audio file 140 previously downloaded from the remote third party server 100. The lyrical content 150 may be provided by a different remote third party server 100 or the same third party server that provided the audio file 140. In a preferred embodiment, when the user plays the audio content from the identified audio file 140, the lyrical content 150 plays on top of the audio file 140 to display lyrics from the lyrical content 150 when desired by the individual user. For example, when an audio file 140 is playing, the audio file 140 may display with the words of the lyrics scrolling, or stationary, anywhere on the display 170. One may wish to view the audio file's album artwork while the file is playing. In such a case, the lyrics would be displayed on top of the album artwork or any other visual cues the user wishes to display.

Among the many different possibilities contemplated, the system may be utilized to allow for lyrical information for digital music to be provided.

Additionally, in an exemplary embodiment, the system and method may allow for lyrical content to be provided to an individual user when no such information is provided with the musical content.

In yet another exemplary embodiment, it is contemplated that the system and the method may allow for download of digital media from a remote third party server 100. Digital media are available for download from a variety of online sources, as well as from a user's own computer when the user has purchased a physical copy of the digital media. Often times, a user acquires music by purchasing an individual song or complete album from an online retailer. Other times, a user purchases an audio album from a physical retailer, intending to listen to the audio album on their portable music device. In such a case, a user rips the audio files from a CD, for example, to transfer onto their home computer. Once on the home computer, a user may transfer the digital media to their portable music device.

In another exemplary embodiment, it is contemplated that the system and method allows for separate download of digital audio file 140 and lyrics 150 from separate third party remote servers 100. Even when audio files 140 are downloaded from a remote third party server 100 or a user's computer 110, and then lyrics are downloaded from a different remote third party server 100, the lyrical file 150 may associate with the downloaded content to provide lyrics corresponding to the audio file 140.

Another exemplary embodiment is that a system and method is provided whereby the lyrical content 150 may be separately downloaded for a particular digital music content after the digital music content has first been downloaded. Most of the time, a user will have digital music content for which they desire corresponding lyrics. In such a case, lyrical content may be downloaded to correspond with the digital music content that has already been downloaded.

A further exemplary embodiment contemplates that the system and method may allow for lyrical content 150 along with video content such as pictures, movies, and the like to be packaged together and downloaded to an individual personal music player device 160 and combined with digital information such as music already stored in said device. In addition to lyrics, a user may wish to view other content simultaneously, such as album artwork, artist information or song length. Thus, when lyrical content 150 is downloaded, video content may also be downloaded to accompany the lyrical content.

Further, a contemplated embodiment of the system and method is to provide lyrical content 150 which may be combined and separated from the music on the portable digital player device 160 as desired by the individual. For example, the individual user may want the lyrics displayed with the music to learn the words of the music that exists in storage of the portable player device. However, after the individual user has learned the particular lyrics of the music stored, they may wish to separate the musical content from the lyrics such that the lyrics are no longer displayed and the individual user may know the lyrics by memory instead of needing to visually see the text of the lyrics.

Additionally, in an exemplary embodiment, a system and method is provided such that lyrical content 150 is downloaded that may be combined and separated from the music on the portable digital player device 160 as desired by the individual and further wherein video or graphical information is provided with the lyrical content to allow for easier memorization of lyrics for a particular music content embodied on the portable music device. For example, the individual user may want to learn the lyrics for a particular musical piece, but finds it difficult to follow the lyrics displayed. The present invention may combine the lyrical content with visual cues, graphical content, and other visual information to facilitate faster learning, or easier understanding of the lyrics embodied in the desired musical piece. However, after the individual user has learned the particular lyrics of the music stored, they may wish to separate the musical content from the lyrics such that the lyrics are no longer displayed and the individual user may know the lyrics by memory instead of needing to visually see the text of the lyrics.

A further exemplary embodiment of the present invention may be to provide lyrical content 150 to a user whereby the user may download the lyrical content 150 for each individual music piece embodied on their portable player device 160.

Additionally, in an exemplary embodiment, a portable music device 160 may include any device that is capable of playing music and having a display, including, but not limited to, a cellular phone, a MP3 player, a portable tablet, a DVD or CD player, a radio with text capability, or a television. Users may select the device 160 they use to play music such that they are able to view lyrics with their music on an ever expanding number of devices, without having to input lyrical information themselves. Whether they are at home listening to music through their television, on the road listening to their radio or car television, or on the go with their cellular phone, a user is able to view lyrical information while listening to their music.

Further, a contemplated embodiment of the system and method is provided such that the lyrical content 150 may be synchronized to music in three dimensional or other dimensional format. With the increasing popularity of the three dimensional format, users may enjoy an experience in which they are immersed in their music.

A further exemplary embodiment of the present invention may be provided such that the lyrical content 150 data may be streamed or populated across a radio screen or the portable device 160 screen 170 when such lyrical file data is available. The location of the lyrics on the screen 170 (top, middle, bottom) can be adjusted by the user according to their preference.

Another exemplary embodiment is provided where the individual user may vary by speed and amount by which the lyrics are displayed. A user may go as slow as viewing one word at a time or viewing entire verses, according to their desire.

Similarly, a further embodiment may include options for the individual user to change the appearance of the lyrics that are displayed. Further personalization options may be employed such that the user can alter the appearance of the lyrics so that they are pleasing to the user. Such personalization options may include changing the lyrics' font, color, size, and shape.

Additionally, in an exemplary embodiment, an individual user may highlight, notate, or copy one or more words of the lyrics that are displayed. Frequently, lyrics are hard to discern and subject to confusion among different users. With the ability to highlight, notate or copy words from lyrics, users can instantly alert other people to the correct lyrics in a simple and straightforward manner.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

What is claimed is:

1. A method for providing lyrics for a portable music device, the method comprising the steps of:
downloading an audio file from a remote third party server; wherein the audio file contains audio content;
providing a lyrical file having only lyrics associated with the audio file previously downloaded from the remote third party server, whereby the lyrical file may be provided by a different third party server or the same third party server that provided the audio file;
playing the audio content from the identified audio file; and
compiling the lyrical file on top of the audio file to display lyrics from the lyrical file when desired by the individual user.

2. A method as recited in claim 1, wherein the lyrical file further includes any of the lyrics for the audio file and includes other visual portions.

3. A method as recited in claim 2, wherein said visual portions include pictures, video display, and other visual cues to facilitate the individual user to learn the lyrics for a particular audio file.

4. A method as recited in claim 1, wherein the audio file contains no visual content.

5. A method as recited in claim 1, wherein said lyrical file is removably displayed on the portable music device and is displayed and withdrawn as desired by the individual user.

6. A method as recited in claim 1, wherein the lyrical file is displayed on the portable music device as desired by the individual user.

7. A method as recited in claim 1, wherein the lyrical file may be synchronized to music in three dimensional or other dimensional format.

8. A method as recited in claim 1, wherein the lyrical file data may be streamed or populated across a radio screen or the portable device screen when such lyrical file data is available.

9. A method as recited in claim 1 wherein the portable media device may be a cellular phone, a MP3 player, a portable tablet, a DVD or CD player, a radio with text capability.

10. A method as recited in claim 1, wherein the individual user may vary by speed by which the lyrics are displayed.

11. A method as recited in claim 1, wherein the individual user may change an appearance of the lyrics that are displayed.

12. A method as recited in claim 1, wherein the individual user may highlight, notate, or copy one or more words of the lyrics that are displayed.
